(19) United States
(12) Patent Application Publication
(10) Pub. No.: US 2013/0118986 A1
(43) Pub. Date: May 16, 2013

(54) High Capacity Oxoanion Chelating Media From Hyperbranched Macromolecules

(71) Applicants: Mamadou S. Diallo, Pasadena, CA (US); Changjun Yu, Pasadena, CA (US); Himanshu Mishra, Pasadena, CA (US)

(72) Inventors: Mamadou S. Diallo, Pasadena, CA (US); Changjun Yu, Pasadena, CA (US); Himanshu Mishra, Pasadena, CA (US)

(21) Appl. No.: 13/734,917

(22) Filed: Jan. 4, 2013

Related U.S. Application Data
(63) Continuation-in-part of application No. 13/633,088, filed on Oct. 1, 2012.
Application No. 13/633,088 is a division of application No. 12/573,708, filed on Oct. 5, 2009, now Pat. No. 8,277,664.
(60) Provisional application No. 61/102,792, filed on Oct. 3, 2008.
(60) Provisional application No. 61/583,530, filed on Jan. 5, 2012.
(60) Provisional application No. 61/603,057, filed on Feb. 24, 2012.

(51) Int. Cl. C08G 73/02

(52) U.S. Cl. CPC C08G 73/0206
USPC 210/670; 525/540; 428/402; 210/683

(57) ABSTRACT

A resin is provided for selectively binding to certain anions in aqueous solution. The beads are prepared by cross-linking macromolecules such as hyperbranched PEI, and functionalizing with groups containing vicinal diol moieties.

### CROSS-REFERENCE TO RELATED APPLICATIONS

This application is a continuation-in-part of co-pending U.S. patent application Ser. No. 13/633,088 entitled “Extraction of Anions from Solutions and Mixtures using Hyperbranched Macromolecules,” filed Oct. 1, 2012, in the name of inventors Jean FRECHET, Emine BOZ, Mamadou DIALLO, and Yonggui CHI, which is a divisional of U.S. patent application Ser. No. 12/573,708, now U.S. Pat. No. 8,277,664 (issued Oct. 2, 2012), entitled “Extraction of Anions from Solutions and Mixtures using Hyperbranched Macromolecules,” filed Oct. 5, 2009, in the name of inventors Jean FRECHET, Emine BOZ, Mamadou DIALLO, and Yonggui CHI, which claims priority to U.S. Provisional Patent Application Ser. No. 61/102,792, entitled “Extraction of Anions from Solutions and Mixtures using Hyperbranched Macromolecules,” filed Oct. 3, 2008, in the name of inventors Emine BOZ, Jean FRECHET, Mamadou DIALLO, and Yonggui CHI. This application also claims the benefit of priority of U.S. Provisional Patent Application Ser. No. 61/583,530, entitled “High Capacity Boron-Selective Media from Hyperbranched Macromolecules,” filed Jan. 5, 2012, in the name of inventors Mamadou DIALLO, Changjun YU, and Himanshu MISHRA. This application further claims the benefit of priority of U.S. Provisional Application Ser. No. 61/603,057, entitled “High Capacity Boron-Selective Media from Hyperbranched Macromolecules,” filed Feb. 24, 2012 in the name of inventors Mamadou DIALLO, Changjun YU, and Himanshu MISHRA. The entire disclosures of each of the above-identified applications are hereby incorporated by reference as if set forth fully herein.

### GOVERNMENT RIGHTS

This invention was made with government support under contract CBET0506951 awarded by the National Science Foundation. The government has certain rights in the invention.

### TECHNICAL FIELD

This subject matter relates generally to the functionalization of porous microspheres with anion-specific hyperbranched polymer structures.

### BACKGROUND

Removal of dissolved oxoanions such as borate from aqueous solutions is important in a variety of applications, such as (1) seawater desalination, (2) ultrapure water treatment in semiconductor manufacturing, (3) the production of high purity magnesium oxides from brines, and (4) nuclear power generation, among other applications.

In one important application, for example, desalination of seawater is increasingly being used in arid coastal areas to produce clean water for human consumption and agriculture. See M. A. Shannon et al. (2008), Science and technology for water purification in the coming decades, Nature, 2008, 452: 301-310. Boron is an essential nutrient for plants; however, it adversely affects plant growth and damages crops (e.g. citrus and corn) when water containing more than about 0.3 mg/L of boron is used in irrigation. See K. Miwa et al., Plant Tolerant of High Boron Levels, Science, 2007, 318: 1417. Boron concentrations in seawater typically range from 0.5 to 5 mg/L. See W. G. Woods, An introduction to boron: history, sources, uses and chemistry, Environ. Health Perspect., 1994, 102(Suppl. 7): 5-11. Although seawater reverse osmosis (SWRO) membranes can achieve rejection levels for ionic species above 99%, the rejection level for boron is less than 70% in most cases. Because of this, one or two additional reverse osmosis passes at high pH (for example, about pH 9) are often used in SWRO desalination plants to increase boron rejection and produce water with acceptable boron concentration (for example, less than about 0.3 mg/L) for irrigation. See Y. Xu & J.-Q. Jiang, Technologies for boron removal, Ind. Eng. Chem. Res., 2008, 47(1): 16-24.

In semiconductor manufacturing, boron is sometimes used as a p-type dopant to silicon. To control the level of boron in a silicon chip, ultrapure water with boron concentrations less than 1 part per billion is used as wafer process and rinse water. See M. O. Simonnot et al., Boron removal from drinking water with a boron selective resin: Is the treatment really selective?, Wat. Res., 2001, 34: 109-116. To achieve this low effluent boron concentration, ultrapure water treatment systems implement costly multistep boron removal systems including (1) multi-pass reverse osmosis (RO), (2) electrodeionization and (3) ion exchange with boron-selective removal resins. See J. Boeseken & N. Vermaas, On the composition of acid boric acid-diol compounds, J Phys Chem., 1931, 35: 1477-89.

In the production of high purity magnesium oxides by pyrohydrolysis of magnesium chloride (MgCl₂) brine, excess boron (more than about 10 parts per million) in the brine can cause embrittlement of the final metal oxide products. See R. R. Grinstead, Removal of boron and calcium from magnesium chloride brines by solvent-extraction. See Ind. Eng. Chem. Prod. Res. Dev., 1972, 11, 454-460.

In nuclear power generation, ¹⁰B-enriched mixtures of boric acid with lithium hydroxide provide inexpensive yet efficient neutron-absorbing media in the primary coolant water of pressurized water reactors. The availability of an efficient and highly selective boric acid recovery system is a key bottleneck for the wide-scale implementation of these neutron absorbing media. See H. Ocken, An Evaluation Report of Enriched Boric Acid in European PWRs; EPRI Report 1003124; Electric Power Research Institute, 2001, B. F. Smith et al., Boric acid recovery using polymer filtration: studies with alkyl monool, diol, and triol containing polyethylenimines. J. Appl. Polym. Sci., 2005, 97: 1590-1604.

Sorption with selective and regenerable resins has emerged as an efficient and cost-effective process for extracting boron from aqueous solutions. In aqueous solutions, whether H₃BO₃ or B(OH)₄⁻ is the predominant boron species may be determined by the pH of the solution [H₃BO₃ (aq), pKa=9.24]. It is known that borate and other oxoanions can selectively complex with organic moieties containing two or more vicinal hydroxyl groups (e.g., diols). See A. I. Vogel et al., Quantitative Inorganic Analysis, Longman, 1987. For example, host functionalization with diol-bearing compounds has been carried out on a variety of polymeric matrices and hybrid organic—inorganic mesoporous materials to synthesize boron-selective ligands and sorbents. See B. F. Smith et al., Boric acid recovery using polymer filtration: studies with alkyl monool, diol, and triol containing polyethylenimines. J. Appl. Polym. Sci., 2005, 97: 1590-1604; Simonnot et al., supra; O. Kaftan et al., C. Y. Synthesis, characterization and application of a novel sorbent, glucamine-modified MCM-41, for the removal/preconcentration of boron from waters, Anal. Chim. Acta, 2005, 547: 31-41; M. Gazi, G. Galli & N. Bicak, The rapid boron uptake by multihydroxyl functional hairy polymers, Sep. Purif. Technol., 2008, 62: 484-488.

Commercial boron-chelating resins have been prepared by functionalization of cross-linked styrene-divinylbenzene (STY DVB) beads with diol-bearing compounds such as N-methylglucamine. Boron-selective resins such as the commercial Amberlite IRA-743 resin are prepared by functionalization of cross-linked STY-DVB beads using a two-step process. In the first step, chloromethyl groups are attached to the STY-DVB resins via a Friedel-Crafts reaction involving the aromatic rings of the resin and an alkyl halide such as chloromethoxymethane in the presence of a Lewis acid catalyst. In the second step, the chloromethyl groups are reacted with N-methylglucamine to produce boron-chelating resins with vicinal diol groups. While the amination of chloromethylated STY-DVB beads is a facile reaction, which takes place in high yield, extensive side-reactions including the secondary cross-linking of the aromatic rings of STY-DVB beads via “methylene bridging” occur during chlomethylation. This reduces the number of functional sites available for amination and, as a result, STY-DVB resins with N-methylglucamine groups such as the Amberlite IRA-743 resin have a limited capacity with a maximum free base of 0.7 eq/L, which corresponds to a sorption capacity of 1.09 mMol/g in aqueous solutions with equilibrium boron concentration of about 100 mM. See Y. K. Xiao et al., Ion exchange extraction of boron from aqueous fluids by Amberlite IRA 743 resin, Chin. J. Chem, 2003, 21: 1073-1079.

Thus, there is a great need for more efficient and cost effective processes and media for recovering borates and other oxoanions from aqueous solutions.

### SUMMARY

The present disclosure relates to new categories of resins that can selectively extract oxoanions from aqueous solutions. Various embodiments are possible, which are exemplified here. These examples in no way limit or otherwise affect the scope or meaning of the claims, and are presented as illustrations only.

In one embodiment, there is provided an oxoanion-selective microparticle comprising a hyperbranched macromolecular structure (A) comprising a plurality of branches, a plurality of terminal functional groups, and a plurality of cross-linking moieties within the same molecular structure; wherein each of said plurality of branches comprises an N-substituted or N,N-substituted n-aminoalkyl moiety (B) comprising one or two substituent moieties; wherein each of said substituent moieties comprises one of the following: (a) another of said plurality of branches; (b) one of the plurality of terminal functional groups; or (c) one of the cross-linking moieties attached at a first cross-linking end, wherein the cross-linking moiety further comprises a second cross-linking end, by which the moiety is also one of said substituent moieties of one of said plurality of branches at a different location within the hyperbranched macromolecular structure A; wherein A has a molecular weight of at least 1500 grams per mole; wherein A comprises essentially no primary amine moieties; and wherein each of the plurality of terminal functional groups comprises a vicinal diol moiety.

In another embodiment, there is provided an oxoanion-selective microparticle prepared by the following process: (a) providing a branched polyethyleneimine molecule with a molecular weight of at least 1500 grams per mole; (b) reacting the branched polyethyleneimine molecule with at least one cross-linking agent to produce a cross-linked resin matrix comprising a plurality of primary and/or secondary amine moieties; and (c) after step (b), reacting the cross-linked resin matrix with a functionalization agent comprising a functional group —R, such that each of said primary and/or secondary amine moieties is substituted for the functional group —R, wherein —R is a structure comprising at least one vicinal diol moiety.

In another embodiment, there is provided a method for filtering oxoanions from an aqueous solution, comprising: providing a solution containing a first quantity of an oxoanion; providing a stationary bed comprising the microparticles as described above, having voids between said microparticles to allow the passage of an aqueous solution; passing said solution through said stationary bed; and recovering said solution after it passes through said stationary bed.

### BRIEF DESCRIPTION OF THE DRAWINGS

The accompanying drawings, which are incorporated into and constitute a part of this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification or the common knowledge within this field.

In the drawings:

FIG. 1 is a diagram showing two equivalent chemical formulas illustrating an example of hyperbranched poly(ethyleneimine) polymers, which may in one embodiment be used as building blocks for the synthesis of oxoanion-selective media.

FIG. 2 is a chemical equation illustrating selective coordination of borate with an organic moiety containing two vicinal diol groups.

FIG. 3 is a chemical equation illustrating selective boron-sugar tetradentate complex formation.

FIG. 4 is a chemical equation illustrating an example of the synthesis of a particular hyperbranched poly(ethyleneimine) media (microparticles), designated in this disclosure as BPEI-1.

FIG. 5 is a diagram containing chemical equations illustrating a reaction scheme for synthesizing BSR-1 and BSR-2.

FIG. 6 is a chemical equation illustrating an example of the synthesis of an oxoanion-selective microparticle, designated in this disclosure as BSR-1, by functionalization of BPEI-1.

FIG. 7A is a scanning electron micrograph of oxoanion-selective media BSR-1 at a reference magnification of 200 μm. FIG. 7B is a scanning electron micrograph of oxoanion-selective media BSR-1 at a reference magnification of 2 μm.

FIG. 8 is a chemical equation illustrating an example of the synthesis of high capacity oxoanion-selective media by functionalization of BPEI-1 with mannitol epoxide.

FIG. 9 is a chemical equation illustrating an example of ultra-high capacity oxoanion-selective media by functionalization of BSR-1 with N-methylglucamine.

FIG. 10 is a diagram illustrating a process for removing borates (and, analogously, other oxoanions) from an aqueous solution.

FIG. 11 is a spectrogram illustrating FR-IR spectra of a BSR-2 resin and corresponding base PEI resin BPEI-2.

FIG. 12A is a scanning electron micrograph of oxoanion-selective media BSR-1 at a reference magnification of 20 μm. FIG. 12B is a scanning electron micrograph of oxoanion-selective media BSR-2 at a reference magnification of 200 μm.

FIG. 13 is a particle size distribution graph comparing particle size (horizontal axis) with volume (vertical axis) for sample BSR-2 resin beads in accordance with an embodiment described in this disclosure.

FIG. 14A is a graph illustrating sorption of boron onto BSR-1, BSR-2 and Amberlite IRA743 resins in deionized water. FIG. 14B is a graph illustrating additional sorption results for duplicate BSR-1 and BSR-2 tests.

FIG. 15 is a graph illustrating sorption isotherms of boron onto BSR-1 and BSR-2 resins in 0.1 M NaCl and simulated seawater RO permeate.

FIG. 16 is a graph illustrating sorption isotherms of boron onto regenerated BSR-1 and BSR-2 resins in deionized water.

### DETAILED DESCRIPTION

In this disclosure there are presented various embodiments of inventions relating to a new family of resins that can selectively extract oxoanions from aqueous solutions. As described herein, it is possible to produce high capacity media that can selectively bind oxoanions in aqueous solutions of varying ionic strength, including for example: (i) reverse osmosis (RO) permeate, (ii) brackish water and (iii) seawater, among other possibilities. These media may be used in numerous applications, including desalination, ultrapure water treatment, the production of high purity magnesium oxide from brines, and in nuclear power applications. It is possible to synthesize recyclable oxoanion-selective media comprising spherical beads with higher binding capacity than those of commercial oxoanion-selective resins. This method is an improvement over the prior art in terms of versatility, simplicity, and scalability of the synthetic methods.

In one embodiment, for example, crosslinked branched polyethylenimine (PEI) beads may be obtained from an inverse suspension process, and can be reacted with glucono-1,5-D-lactone to afford a resin comprising spherical beads with high density of oxoanion-chelating groups. When applied to borates, this regenerable resin may be expected to have a sorption capacity of 1.93±0.04 mMol/g in aqueous solutions with equilibrium boron concentration of about 70 mM, which is 66% percent larger than that of standard commercial STY-DVB resins. In general, cross-linked branched PEI beads may provide versatile and promising building blocks for the preparation of regenerable oxoanion-chelating resins with high binding capacity.

Those of ordinary skill in the art will understand that the following detailed description is illustrative only and is not intended to be in any way limiting. Other embodiments of the present inventions will readily suggest themselves to such skilled persons having the benefit of this disclosure, in light of what is known in the relevant arts. Reference will now be made in detail to exemplary implementations of the present inventions as illustrated in the accompanying drawings.

In the interest of clarity, not all of the routine features of the exemplary implementations described herein are shown and described. In the development of any such actual implementation, numerous implementation-specific decisions must be made in order to achieve the specific goals of the developer, such as compliance with application and business-related constraints, and that these specific goals will vary from one implementation to another and from one developer to another. Moreover, such a developmental effort might be complex and time-consuming, but would nevertheless be a routine undertaking of engineering for those of ordinary skill in the art having the benefit of this disclosure.

Throughout the present disclosure, relevant terms are to be understood consistently with their typical meanings established in the relevant art. However, without limiting the scope of the present disclosure, further clarifications and descriptions are provided for relevant terms and concepts as set forth below:

The term degree of branching (DB) has a meaning known in the field, and use herein is consistent with that meaning A definition is provided, for example, in C. J. Hawker, R. Lee, and J. M. J. Fréchet, The One-Step Synthesis of Hyperbranched Dendritic Polyesters, J. Am. Chem. Soc., 1991, 113: 4583. The degree of branching may be defined by the formula:

$$DB = \frac{Σ D + Σ T}{Σ D + Σ T + Σ L}$$

where Σ D is the sum of dendritic units, Σ T is the sum of terminal units, and Σ L is the sum of linear units. The terms dendritic units, terminal units, and linear units have their normal meaning as understood by those of skilled in the field. The degree of branching may be determined in several different ways, including directly through analysis of the structure, and indirectly through characterization of ¹³C-NMR spectra or other indirect means known in the art.

The terms hyperbranched polymer and hyperbranched as used herein refer to their definitions as known to those of skill in the art. A hyperbranched polymer comprises polydisperse dendritic macromolecules which are generally prepared in a single synthetic polymerization step that forms imperfect branches, generally in a non-deterministic way. However, there are many synthetic strategies known in the art to prepare hyperbranched polymers with lower polydispersity. They are typically characterized by their degree of branching (DB). An amine-based hyperbranched polymer may comprise tertiary, secondary, and primary amines, unless it has been modified, in which case the primary amines might as an example be converted to secondary and/or tertiary amines and secondary amines might, for example, be converted to tertiary amines, leading the same imperfect branched structure.

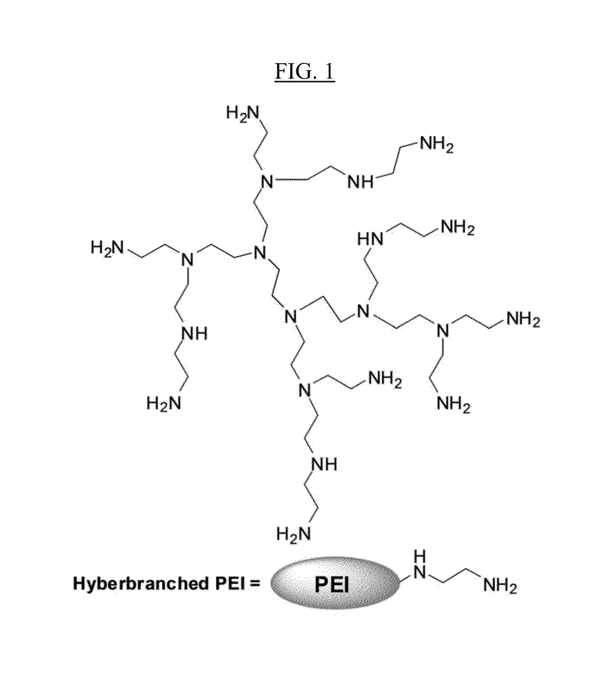

The terms hyperbranched polyethyleneimine (PEI) polymer, or simply polyethyleneimine, or PEI, refers to a class of hyperbranched polymers known in the art. Generally, PEI polymers typically have a degree of branching (DB) of approximately 65-70%, consisting of primary, secondary, and tertiary amines, the amines being linking by C₂ alkyl chains. PEI with various molecular weights (MW) ranging from about 1,000 to several million Daltons are commercially available. Among many ways known in the art for preparing hyperbranched PEI, one is through ring opening polymerization of aziridine. A diagram showing two equivalent chemical formulas illustrating an example of hyperbranched poly(ethyleneimine) polymers, which may in one embodiment be used as building blocks for the synthesis of oxoanion-selective media is illustrated in FIG. 1.

The term moiety as used herein refers to any part of an organic molecule, and may include, without limitation, a functional group, an alkyl chain, a branch of a branched molecule, or a continuation of a branched structure.

The term diol as used herein refers to a part of an organic molecule containing at least two hydroxyl groups, an example of which is a polyol, glycol, or sugar which may contain several hydroxyl groups. A vicinal diol is a diol in which at least two of the molecule's hydroxyl groups are in vicinal positions.

The term boron refers to a chemical element which has a meaning known in the field. Reference herein to “boron” in an aqueous solution may refer to boron in the form of borates, which are oxoanions of boron.

In water, boron may be expected to exist in the form of borate, BO₃³⁻. In solution, borate may hydrolize according to the following reaction:

H₃BO₃+H₂O→H⁺[B(OH)₄]⁻ K=5.8×10⁻¹⁰ mol/L

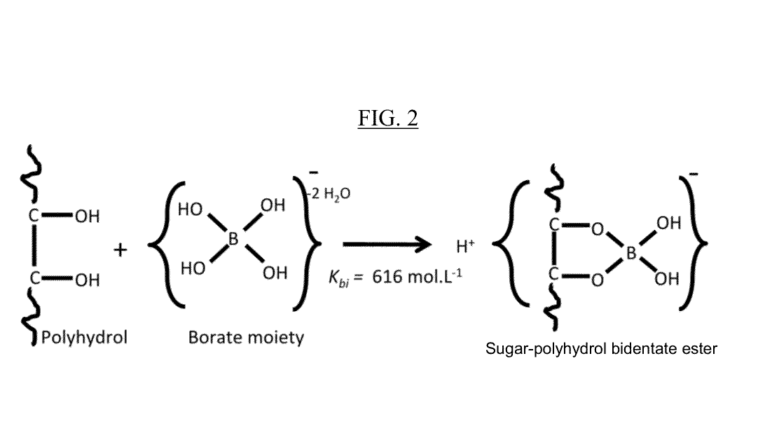

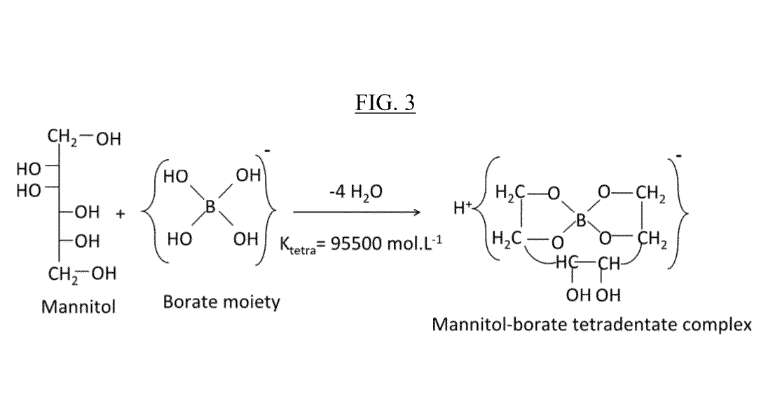

The borate moiety may chelate either as a bidentate, or as a tetradentate complex with vicinial diol systems. These chelated-ring-systems are relatively stable. An example of borate binding to vicinial diols is illustrated in FIG. 2, which shows the selective binding of a borate moiety to a polyhydrol, to form a sugar-polyhydrol bidentate ester. Another example is shown in FIG. 3, which illustrates the binding of a borate moiety to mannitol, to produce a mannitol-borate tetradentate complex. Other sugars comprising at least four hydroxyl groups may be equally suitable.

The term oxoanion as used herein refers to an anion of the generic formula AₓO_{y}^{z-}, where A represents a chemical element, O represents the oxygen atom, and x, y, and z are positive integers. Example oxoanions may include, inter alia, borate, germinate, arsenate (V or III), vanadate, molybdate, or tungstate. These listed oxoanions are known in the art to be equivalent in terms of their ability to bind to diol groups. See, e.g., Z. Mat\check{e}jka et al., “Selective Uptake and Separation of Oxoanions of Molybdenum, Vanadium, Tungsten, and Germanium by Synthetic Sorbents Having Polyol Moieties and Polysaccharide-Based Biosorbents,” in Fundamentals and Applications of Anion Separations, Moyer & Singh, eds., Kluwer Academic/Plenum Publishers, New York, 2004. Therefore, one of skill in the art will understand that the borate-specific examples described herein will also apply to these other oxoanions.

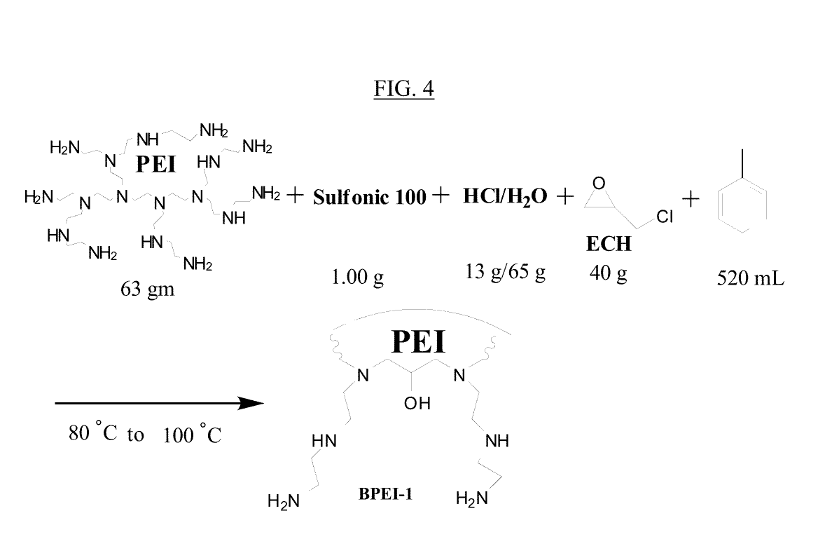

In one embodiment, a class of spherical beads, designated herein as BPEI-1, may be prepared. This class of beads may be created as shown in FIG. 4. This figure is a chemical equation illustrating a hyperbranched polyethyleneimine (PEI) macromolecule which is cross-linked in inverse suspensions of toluene and water stabilized by a surfactant (for example, benzyl dodecyl sulfonic acid, although other surfactants are appropriate) using epichlorohydrin (ECH) as a cross-linker. Other cross-linkers may be used with equal effect. Cross-linkers may be expected to have a carbon or other organic chain, with at least two functional groups capable of binding to the primary and secondary amines of the PEI. What results is a cross-linked hyperbranched class of macromolecules, referred to here as BPEI-1.

The synthesis described in FIG. 4 may proceed as follows: A Morton-type flask (one liter) may be used, equipped with an overhead mechanical stirrer, a thermometer, a reflux condenser, an additional funnel, and an inert gas port. To the flask may be added 63 g of water-free PEI. While the flask is cooled in a water bath, a solution of 36 g of concentrated HCl in 42 g of DI-water may be added with an occasional shaking To this warm PEI solution may be added a mixture of 1 g of sulfonic 100 (acid form of a branched surfactant) in 4 mL of 1.1 N sodium hydroxide solution. After shaking well, 450 mL of toluene may be added and the mixture may be stirred at an oil bath with temperature set at 80° C. under nitrogen. After 30 min, a solution of 40 g of ECH (epichlorohydrin) in 70 mL of toluene may be added through an additional funnel within 45 min. The mixture may be stirred for another 30 min after completion of ECH solution and then temperature may be adjusted to 110° C. and a dehydration process using a dean stark apparatus may be initialed until about 30 mL of water is collected. After cooling to room temperature, top solvents may be decanted, 400 mL of methanol may be added and the resulting beads may be filtered off and washed twice with methanol. The resulting beads may be transferred into 600 mL of 3 N NaOH solution. The beads may be filtered off and washed three times with DI-water. Size and size distributions of these beads may be measured using standard equipment and procedures. The PEI beads may be directly used for next step reaction. This procedure is for illustrative purposes, and the specifics of this procedure may be modified according to principles of chemical synthesis known in the art.

Reagent grade chemicals may be used to synthesize all the base PEI beads and oxoanion-selective PEI resins described herein. Precursor polyethylenimine macromolecules (PEI) (e.g., SP-018 (molecular weight Mₙ=1800) and SP-200 (Mₙ=10,000)) may be purchased from several commercial sources, for example, from Nippon Shokubai Co., Ltd. of Japan. Although commercial-grade PEI is used in this example, other hyperbranched molecules based on amine linkages may also be used, and the hyperbranched macromolecule can be expected to have a wide variety of possible degrees of branching. The degree of branching is expected to affect the size and efficiency of the ultimate bead.

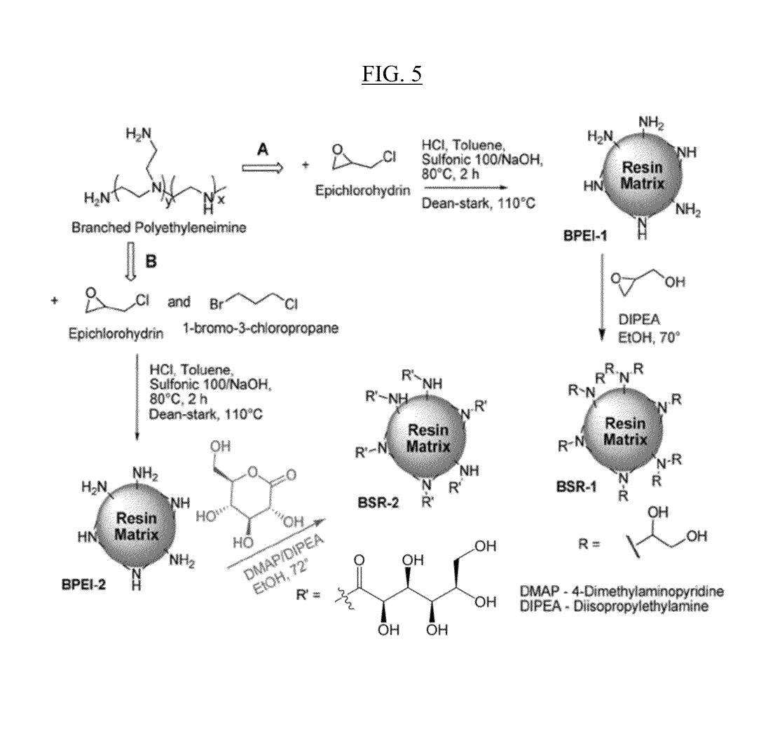

In an alternate embodiment to the production of BPEI-1, one may create a class of spherical resin matrix referred to herein as BPEI-2. This class may be prepared as illustrated in the reaction schemes shown in FIG. 5, which also illustrates the production of BPEI-1 and BSR-1 classes of beads. As it relates to BPEI-2, during the first step, two branched PEI macromolecules (for example, with molar mass (Mn) of 1800 and 10,000 Da) may be, respectively, cross-linked with a mixture of epichlorohydrin (ECH) and 1-bromo-3-chloropropane (DCP) to afford spherical beads, in one embodiment using the inverse suspension process described by H. T. Chang et al., U.S. Pat. No. 7,342,083 B2 (2008).

An exemplary lab procedure for the production of BPEI-2 is as follows: A 1 L Morton-type round bottom flask equipped with a mechanical stirrer, a thermometer, a reflux condenser, an addition funnel, and an inert gas port may be used. A solution of 86 g of HCl (36-38% wt solution) in 138 g of DI water may be added to the reaction flask containing 100 g of PEI over a course of 10 min at room temperature under nitrogen. Then a solution of 4 mg of surfactant [Sulfonic 100+1.1 M NaOH] may be added to the vessel, followed by the addition of 450 mL of toluene. The oil bath temperature may then be brought to 80° C. In a separate vessel, a toluene solution (40 wt %) containing 50 g of epichlorohydrin (ECH) and 100 g of 1-bromo-3-chloropropane (BCP) may be prepared. The ECH/BCP solution may be added to the reaction mixture over a 60 min period. The reaction may be continued for an additional 2 h. Following this, the dehydration of the reaction mixture may be initiated using a Dean stark apparatus at a temperature of 110° C. The reaction end point can expected to be reached when all the water from the system had been removed. After cooling to ambient temperature, the BPEI-2 beads may be collected by filtration over a Buchner funnel. The beads may then be washed with methanol and a solution of NaOH (20 wt %) to remove the surfactant. Following this, the beads may sequentially be washed with DI water, NaCl (5 wt %) and DI water. The beads may then be filtered off and stored at room temperature. This procedure is for illustrative purposes, and the specifics of this procedure may be modified according to principles of chemical synthesis known in the art.

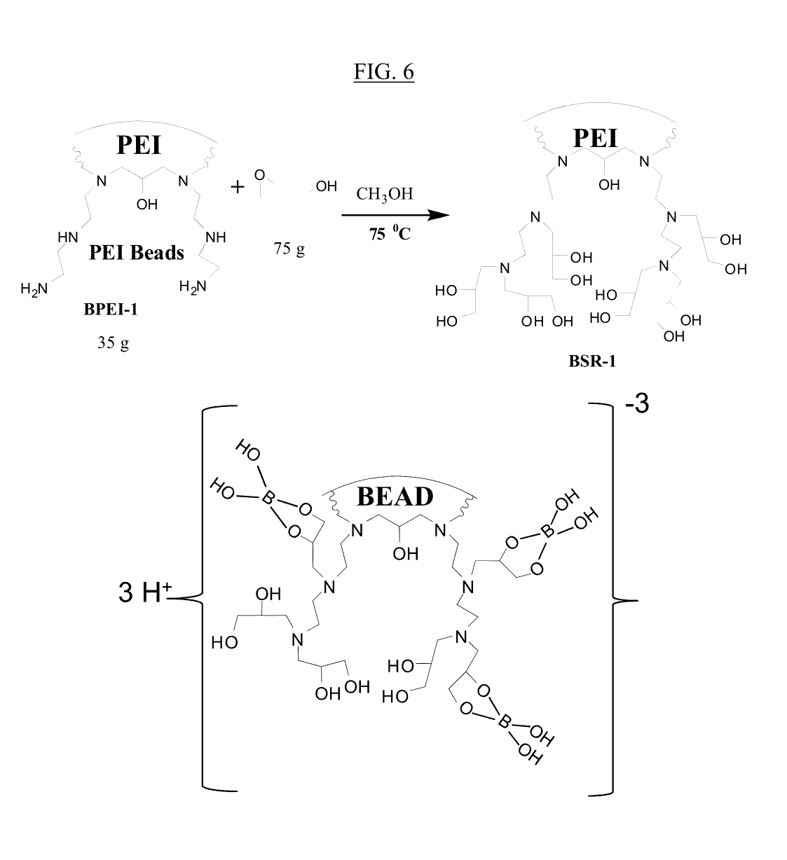

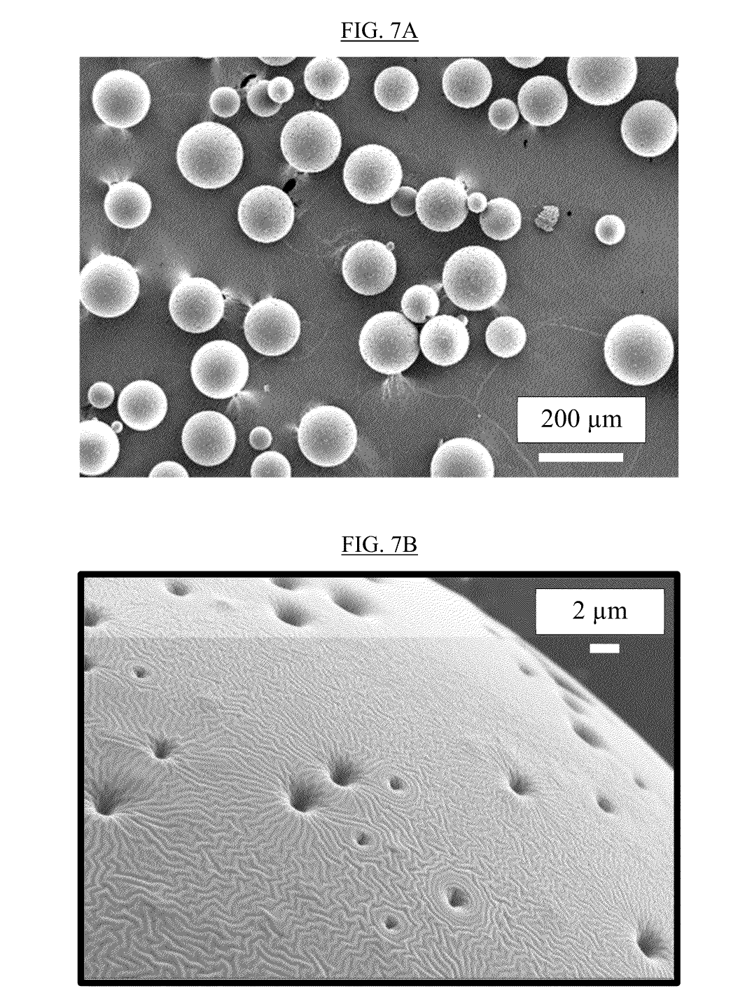

Because oxoanions can form strong complexes with diols, the BPEI-1 or BPEI-2 beads may be functionalized, in one embodiment, as illustrated in FIG. 6. In this example, methyl-hydroxy oxirane may be used to form vicinal-diol functional groups on the primary and secondary amine groups of the BPEI-1 beads. This class of oxoanion-selective resins derived from BPEI-1 beads is referred to herein as BSR-1. FIG. 6 also illustrates an example of the complex of borate with BSR-1 beads. FIG. 7A and B are scanning electron microscopy (SEM) images of exemplary BSR-1 beads. Alternatively to methyl-hydroxy oxirane, ethyl- or longer-chain diol- or polyol-substituted oxiranes may also be used in the same manner (e.g., 1,2-dihydroxy-3,4-epoxybutane, or 1,2,3-trihydroxy-4,5-epoxypentane, etc.).

The synthesis illustrated in FIG. 6 may proceed as follows: To 300 mL of pressure vessel may be added 35 g of the wet PEI beads (designated above as BPEI-1), 60 mL of methanol and 75 g of glycidol. The vessel may be sealed and heated for 3 hours in an oil bath with temperature at 75° C. After cooling to room temperature, the cap may be removed, and the bead materials may be filtered off and wash three times with methanol and three times with DI-water. The diol-attached PEI bead, BSR-1, may therefore be obtained. Again, this procedure is for illustrative purposes only, and the specifics of this procedure may be modified according to principles of chemical synthesis known in the art.

In one alternative embodiment, a different functionalized oxoanion-specific bead, designated as BSR-2, may be prepared from either BPEI-1 or BPEI-2, as shown in FIG. 5. This figure shows that in the step after the production of BPEI-2, the PEI beads (e.g., prepared using the PEI precursors with Mₙ=1800 and 10 000 Da) may be functionalized with glucono-1,5-_{D}-lactone to prepare BSR-2 with oxoanion-chelating groups.

This synthesis of BSR-2 may proceed as follows: 150 mL of ethanol (EtOH) may be added into a 350 mL pressure vessel containing 50 g of Buchner dried PEI-2. Then 50 g of D-Glucono-1,5-lactone, 4 g of 4-Dimethylaminopyridine, and 15 mL of DIPEA may be added to the mixture. The reaction mixture may be stirred and heated to 72° C. in a temperature controlled oil bath for 24 h to prepare the BSR-2 beads. After cooling to room temperature, the beads may be collected by filtration over a Buchner funnel and washed with methanol (MeOH) (1 L/10 g of resin) to remove organic reagents and byproducts. After rinsing with deionized water (1 L/10 g of resin), the BSR-2 beads may be washed successively with 1.0 M HCl (1 L/10 g of resin), neutralized with 1.0 M NaOH (1 L/10 g of resin), and then washed with DI water until the pH of the eluate is neutral (˜7.0).

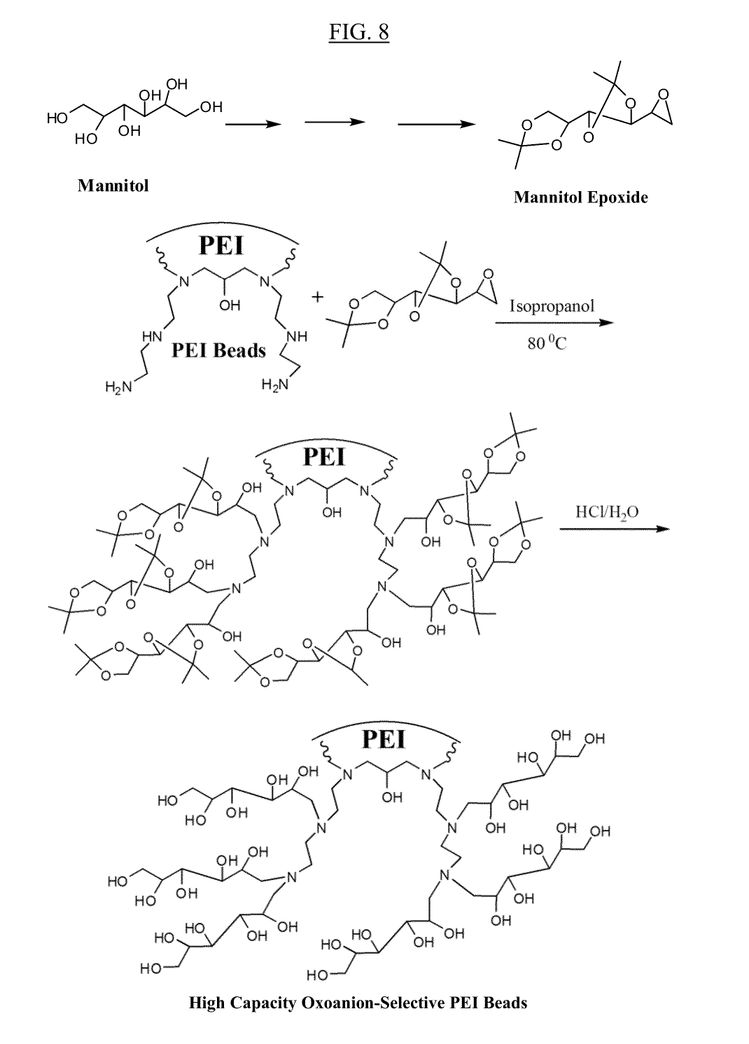

Other embodiments of the above procedures and bead structures are also possible. In another embodiment, FIG. 8 illustrates a different way to functionalize the BPEI-1 class of beads, and represents a quaternized version of beads similar to BSR-1. In this case, the functionalizing agent is mannitol epoxide, which may be reacted with BPEI-1 beads in essentially the same manner as described above with BSR-1. In this case, there is produced selective beads with functional groups containing two sets of vicinal diols, which may form a quaternary complex with an oxoanion in solution.

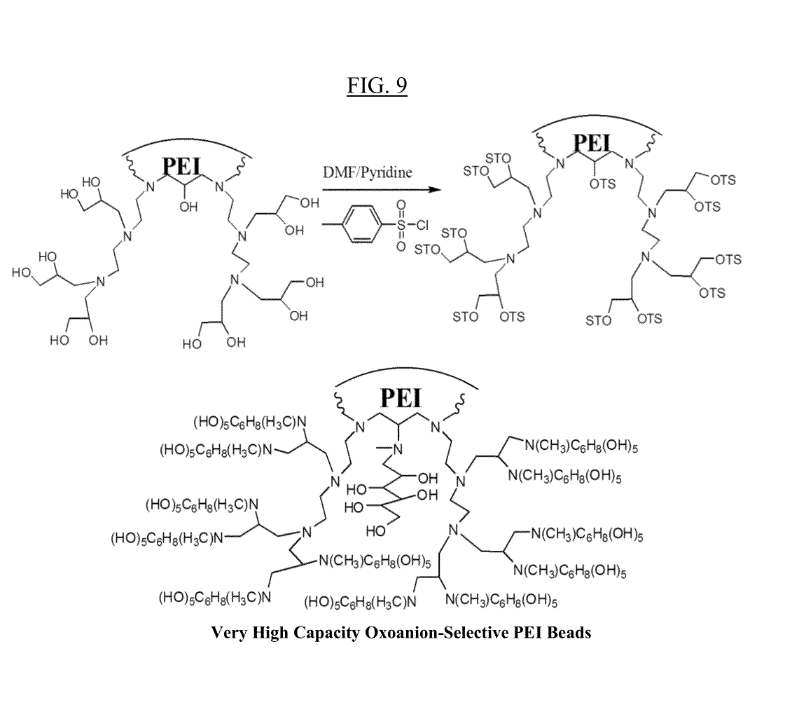

In another embodiment, as illustrated in FIG. 9, the BSR-1 class of beads may be further functionalized. In this example, the —OH groups of BSR-1 beads may be reacted with 4-toluenesulfonyl chloride (TsCl) followed by reaction with n-methyl glucamine to prepare ultra high capacity oxoanion-selective media with very high density of OH groups. In FIG. 9, “TS” refers to the toluenesulfonyl group.

In other embodiments, the illustrative synthetic methods and procedures disclosed herein may be applied to most branched macromolecules with secondary, primary amine and hydroxyl groups. PEI is useful for many reasons, including its high content of reactive primary/secondary amine groups and availability from commercial sources. However, there are other commercially available macromolecules that may be used as well. These may include dendrimers (e.g., poly(amidoamine) [PAMAM], poly(propyleneimine) [PPI] and 2,2-bis (methyl) propionic acid [bis-MPA]) and hyperbranched macromolecules (e.g., Hybrane, bis-MPA and Boltorn hyperbranched polymers). The poly(2-ethyloxazoline) (PEOX) dendrigraft polymers developed by R. A. Kee et al., Semi-controlled dendritic structure synthesis, in Dendrimers and Other Dendritic Polymers, J. M. Frechet & D. A. Tomalia, eds., John Wiley & Sons, 2001, pp. 209-236, may also provide an another starting base polymer with secondary amine groups that can functionalized using the synthetic procedures disclosed herein.

A cross-linked hyperbranched resin such as described above may be functionalized in various other ways, to provide functional groups containing vicinal diol groups.

In one embodiment, the BSR-1 beads, and other classes of beads described herein, may be regenerated by leaching the oxoanions from the beads and reconditioning them. This regeneration may be performed by leaching the oxoanion-saturated beads with 1 N HCl solution for about 30 minutes to strip the borate away, followed by a 0.1 N NaOH rinse for about 20 minutes to regenerate the beads. These times may be varied according to the skill of one working in the field.

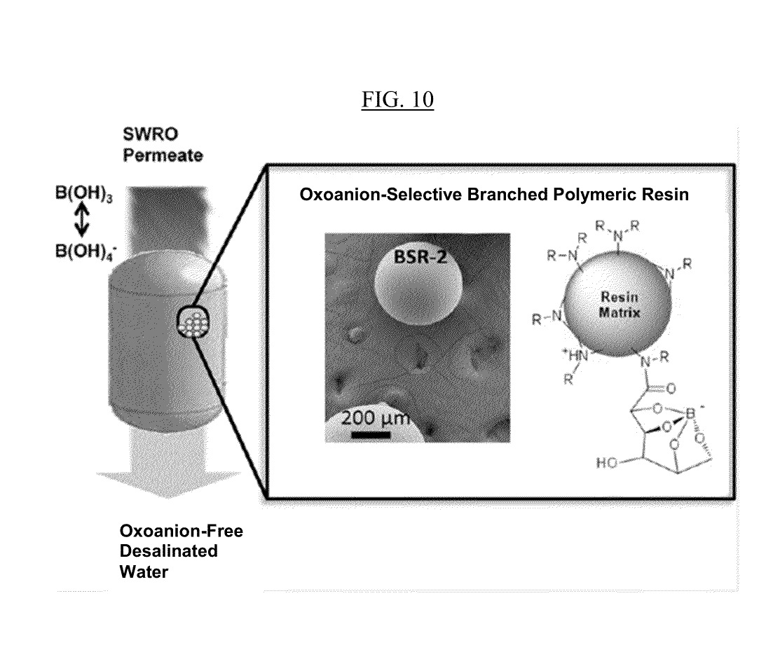

In an embodiment of a use of the beads described herein, one may, for example, filter oxoanions from an aqueous solution. As illustrated in FIG. 10, oxoanion-specific beads may in one embodiment be placed in a stationary bed or column, and passing the water over and through the bed of beads. The beads can remove oxoanions within the aqueous solution. After the bed or column has become saturated with oxoanions, the beads can be regenerated by the means described in this disclosure.

### EXAMPLE: CHARACTERIZATION AND PROPERTIES OF BEADS

In an example to illustrate the characterization and properties of classes of beads described herein, samples of BSR-1 and BSR-2, prepared as described above, were characterized using a broad range of analytical techniques/assays.

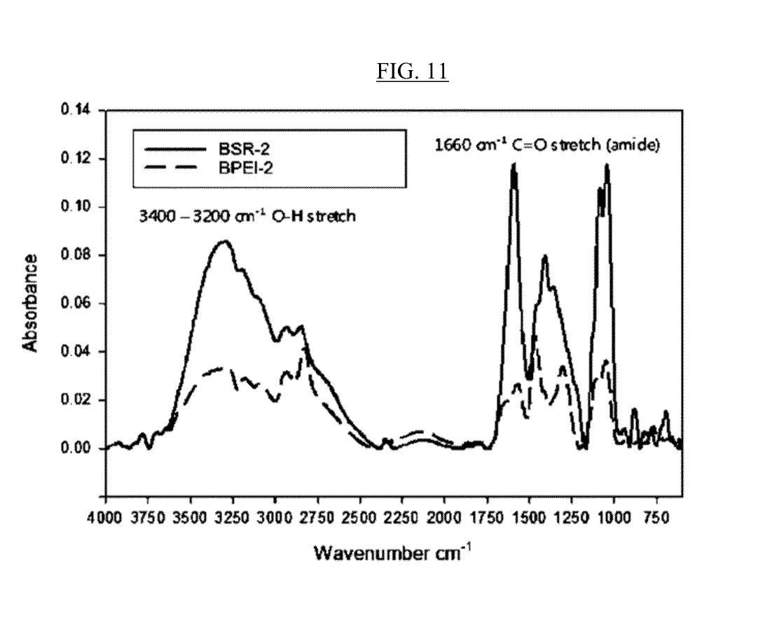

Samples of BSR-1 and BSR-2, prepared as described above, were characterized by FT-IR spectroscopy. FT-IR spectra were acquired using a Bruker VERTEX 70/70v FT-IR spectrometer with potassium bromide (KBr) pellets and OPUS software for data processing. All the reported IR spectra represent averages of more than 100 consecutive scans. FIG. 11 shows the FT-IR spectra of the BSR-2 and BPEI-2 resins. The FT-IR spectrum of the BSR-2 resin exhibits some characteristic features of compounds with amide groups (e.g., C═O stretch at 1660 cm⁻¹) and hydroxyl groups (e.g., OH stretching at 3257 cm⁻¹).

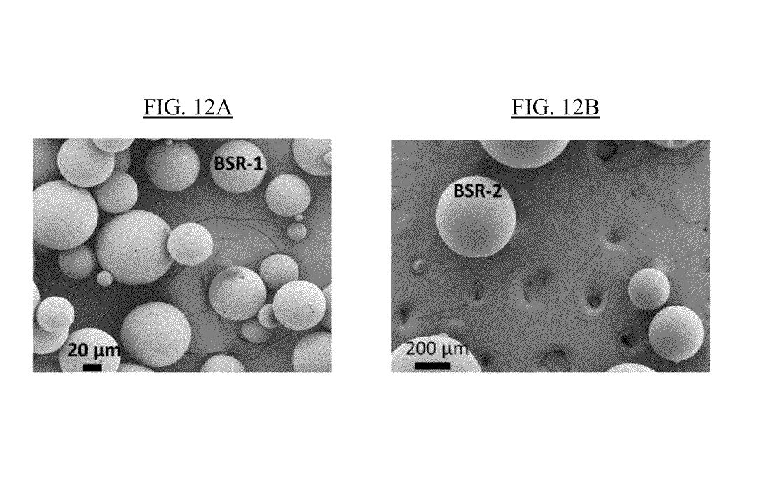

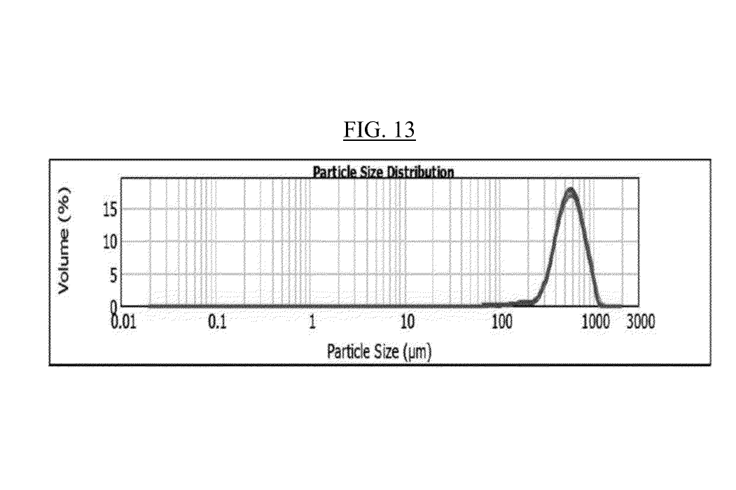

Samples of BSR-1 and BSR-2, prepared as described above, were also characterized by scanning electron microscopy (SEM). The SEM images were acquired using a Zeiss 1500VP field-emission scanning electron microscope. Prior to imaging, each resin sample was coated with a thin and conducting graphite film. The mean diameter of the BSR-2 beads was measured using a Malvern Hydro 2000S particle size analyzer. FIG. 12 shows representative SEM micrographs of the sample BSR-1 and BSR-2 resin beads. Using the ImageJ software, the average diameter of the BSR-1 resin beads is estimated to be equal to 60.4 μm±11. Note that the average diameter of the BSR-1 resin beads is significantly lower than those of STY-DVB resin beads. The particle size distributions (PSD) of such commercial resin beads range from 300 to 1200 μm with a mean diameter of 700 μm. FIG. 13 of the SI shows the PSD of the BSR-2 resin beads is comparable with that of commercial STY-DVB resin beads. In this case, the PSD of the BSR-2 beads, which was measured using a Malvern Hydro 2000S particle size analyzer, range from 352 to 829 μm with a volume-averaged mean diameter of 551 μm.

The water content of each resin was determined by drying a 2 g sample of media in a desiccator at ambient temperature under vacuum and recording its weight until it remained constant. The free base capacity (amine content) of each resin was determined by performing a Mohr titration as described in ASTM 2187 sections 100-109.14. In a typical titration experiment, 4 g of resin was mixed with 10 mL of deionized water. The resin slurry was packed in a graduated cylinder and allowed to equilibrate for 1 h. The bed volume (BV) of the resin was then measured. Subsequently, the resin slurry was packed in a fritted glass column and filled with 1 L of a 1.2 M HCl solution. The acid was passed through the sample at the rate of 20-25 mL/min, keeping the samples submerged in acid at all times. Following this, the liquid was drained to the level of the samples and the effluent liquid was discarded. The column was then washed with 600-750 mL of ethanol until a 10-mL portion of the effluent mixed with 10 mL of water achieved a constant pH>4.0. The chloride ions bound to the protonated amine groups of the resins were then eluted out with a 1 L of 2.0 wt % solution of sodium nitrate (NaNO₃). Following this, the concentration of chloride in the effluent was measured by titrating 100 mL of the effluent solution with a solution of silver nitrate (AgNO₃). The total amine content (TAC) (meq/mL) was expressed as

TAC=V×N×DR/BV

where V and N are, respectively, the volume (mL) and normality (meq/mL) of the AgNO3 solution, BV (mL) is the volume of the swollen resin, and DR is the dilution ratio, which is equal to 10 in this case.

To evaluate the oxoanion-sorption performance of BSR-1 and BSR-2, batch studies have been carried out to measure their sorption capacity in deionized (DI) water and model electrolyte solutions. Batch sorption studies were carried out to measure the boron sorption capacity of the pristine BSR-1 and BSR-2 resins in DI water, 0.1 M NaCl solution, and a model permeate from a seawater reverse osmosis (SWRO) plant (Table 1S of the SI). To benchmark the performance of the BSR-1 and BSR-2 resins, the boron sorption capacity of a commercial STY-DVB resin with boron-chelating groups (IRA-743) in DI water was also measured. Boron sorption onto each resin was measured by mixing known amounts of dry resin with aqueous solutions (at neutral pH) containing varying concentrations of boron. Following equilibration of the vials for 24 h, the amount of boron sorbed onto each resin (Q_{sorbed}) (millimoles of boron per g of resin) was determined using the following equation:

Q_{sorbed}=(C_{bi}−C_{bf})/m

where G_{bi} and C_{bf} are, respectively, the initial and final concentrations of boron (mM) in solution measured by titration and m is the dry-mass of resin (g) per volume of solution (L). In a typical titration experiment, 10 mL of a 0.5 M mannitol solution was first added to an aliquot of 1.0 mL of supernatant solution (analyte) from each equilibrated sorption vial. Excess mannitol ensured complete binding of the dissolved boron and release of protons (H₃O). Subsequently, each analyte was titrated against a 0.05 M NaOH solution (using phenolphthalein as indicator) until it became and remained pink for more than 30 s. The concentration of boron in the supernatant solution (C_{bf}) after equilibration was calculated using the following equation:

C_{bf}=C_{NaOH}×(V_{NaOH}/V_{analyte})

where V_{NaoH} and C_{NaoH} are, respectively, the volume (mL) and concentration (mM) of the NaOH solution, and V_{analyte} is the volume of analyte (mL).

Batch studies were also carried out to measure the oxoanion sorption capacity of the BSR-1 and BSR-2 resins following one regeneration cycle. In a typical experiment, 1 g of resin (dryweight equivalent) was packed in a fritted glass column and eluted with a 50 mM boric acid solution until the effluent concentration was equal to the feed concentration. The resin was regenerated by elution with a 1.0 M HCl solution followed by neutralization with 0.1 M NaOH solution. Each regenerated resin was subsequently washed with DI water until the pH of the rinsewater remained constant (pH˜6.0). The neutralized resins were collected by filtration over a Buchner funnel. Batch sorption studies were subsequently carried out to measure the oxoanion sorption capacity of the regenerated BSRs in DI water using the procedures described above.

For the purpose of illustrating the expected properties of the oxoanion-specific beads described herein, the results of the above characterizations are as follows:

Table 1 lists the total amine contents (TAC) of the examined BSR-1 and BSR-2 resins along with those of their precursor PEI beads (BPE-1 and BPE-2). Table 1 shows that the TAC of the BPEI-1 and BPEI-2 resins are both equal to 9.0 mMol/g. However, consistent with the reaction schemes of FIG. 1, the TAC of the BSR-2 resin (7.21 mMol/g) is lower than that of the BSR-1 resin (8.02 mMol/g).

TABLE 1
Water and total amine contents of oxoanion-
selective and base PEI resins.

| | | | water | total amine |
|---|---|---|---|---|
| | | functional | content | content |
| resin | matrix | group | (%) | (mMol/g) |
| BSR-1 | cross-linked PEI | cis-diol | 37 | 8.02 |
| BSR-2 | cross-linked PEI | pentahydroxy- | 43 | 7.21 |
| | | hexanamide | | |
| BPEI-1 | cross-linked PEI | amines | 68 | 9.0 |
| BPEI-2 | cross-linked PEI | amines | 65 | 9.0 |

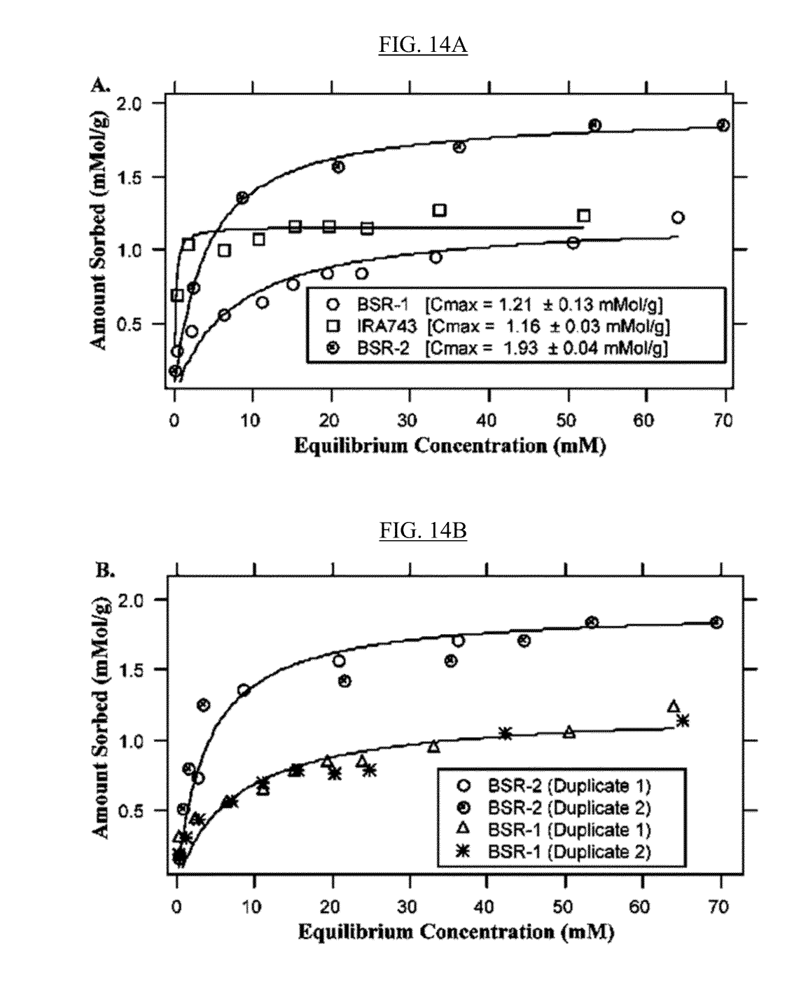

FIG. 14A shows the sorption isotherms of boron onto the BSR-1, BSR-2, and Amberlite IRA 743 resins in DI water. FIG. 14B highlights the reproducibility of the sorption measurements. The target and measured boron concentrations in a series of samples in DI water are within 0.5-3%, thereby confirming the accuracy/precision of the titration method in aqueous solutions with boron concentration >2 mM.

IGOR Pro 620 software was subsequently used to fit each sorption isotherm to a Langmuir model as given below:

Q_{sorbed}=K_{b}CₘₐₓC_{eq}/(1.0+K_{b}C_{eq})

where Q_{sorbed} (mMol/g) is the mass of sorbed boron, Cₘₐₓ (mMol/g) is the resin sorption capacity at saturation, K_{b} (mM⁻¹) is the resin sorption constant, and C_{eq} (mM) is the equilibrium concentration of boron in the aqueous phase. Table 2 lists the estimated Cₘₐₓ and K_{b} values for the BSR-1, BSR-2, and Amberlite IRA-743 resins. Table 2 shows that the boron sorption capacity of the BSR-1 resin in DI water (Cₘₐₓ=1.21±0.13 mMol/g) is comparable to that of the STY-DVB Amberlite IRA-743 resin, which has a sorption Cₘₐₓ=1.16±0.03 mMol/g. Note that the estimated Cₘₐₓ value for the Amberlite IRA-743 resin is very close to the measured value of 1.09 mMol/g reported by Xiao et al. Table 2 shows that the BSR-2 resin has a boron sorption capacity of 1.93±0.04 mMol/g in aqueous solution with equilibrium boron concentration of ˜70 mM. This sorption capacity is 66% percent larger than that of the Amberlite IRA-743 resin. Note that FIG. 14A suggests the Amberlite IRA-743 resin has a higher sorption capacity at lower boron concentration, i.e. ˜2 mM. However, due to the limited sensitivity of this boron detection method by titration, additional studies using more sensitive boron assays are needed to quantify the performance of the oxoanion-selective resins in aqueous solutions containing boron concentrations lower than 2 mM.

TABLE 2
Estimated sorption capacities (Cₘₐₓ) and sorption constants
(K_{b}) for BSR-1, BSR-2 and Amberlite IRA-743 resins
in deionized water and model electrolytes.

| resin | Cₘₐₓ (mMol/g) | K_{b} (mM⁻¹) |
|---|---|---|
| BSR-1 (deionized water) | 1.21 ± 0.13 | 0.13 ± 0.05 |
| BSR-1 (0.1M NaCl) | 1.17 ± 0.08 | 0.32 ± 0.11 |
| BSR-2 (deionized water) | 1.93 ± 0.04 | 0.26 ± 0.03 |
| BSR-2 (SWRO permeate) | 2.13 ± 0.10 | 0.20 ± 0.03 |
| IRA-743 (deionized water) | 1.16 ± 0.03 | 6.60 ± 2.03 |

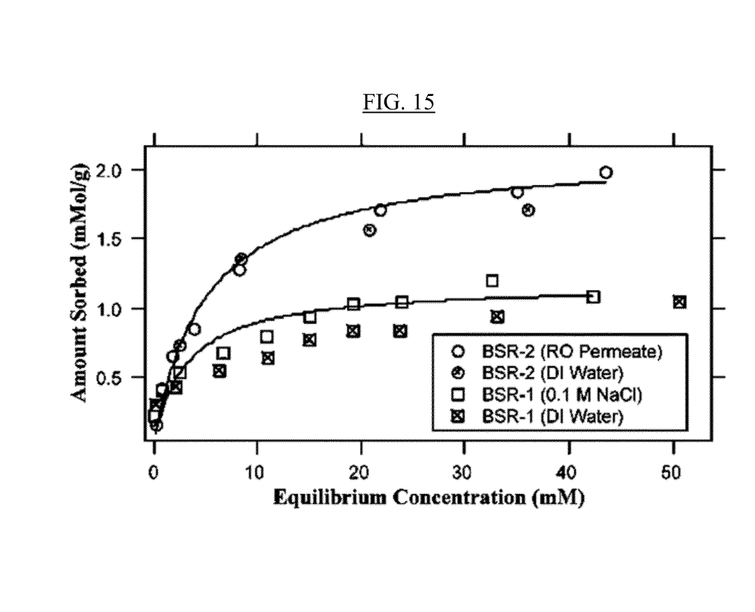

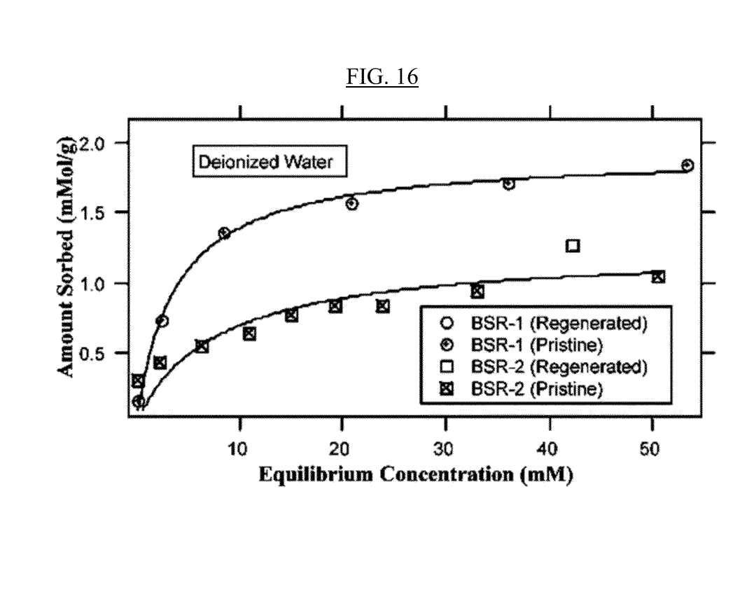

As a preliminary assessment of the selectivity of the BSR-1 and BSR-2 resins, their boron sorption isotherms were measured in (i) a 0.1 M NaCl solution and (ii) a simulated permeate of a SWRO desalination plant. This SWRO permeate consisted of 0.008 mM CaCl₂, 0.052 mM MgCl₂, 2.12 mM NaCl, 0.058 mM KCl, 0.012 mM NaHCO₃, and 0.026 mM Na₂SO₄. FIG. 15 shows a small but consistent increase of boron uptake for the BSR-1 resin in the 0.1 M NaCl solution compared to that in DI water. For the BSR-2 resin, however, this increase is negligible. In this case, the Cₘₐₓ value of the BSR-2 resin in the simulated SWRO permeate is very close to that in DI water (FIG. 15 and Table 2). The regeneration potential of the BSR-1 and BSR-2 resins was also evaluated, by measuring their boron sorption capacity in DI water after eluting the boron-laden resins with a 1.0 N HCl solution followed by a rinse with DI water and a wash with 0.1 N NaOH. Similar regeneration conditions were employed in previous studies of the Amberlite IRA-743 resin. The boron sorption capacities of the pristine BSR-1 and BSR-2 resins in DI water were found not to be affected by regeneration (FIG. 16 and Table 3).

TABLE 3
Estimated sorption capacities (Cₘₐₓ) and sorption
constants (K_{b}) for pristine and regenerated BSR-
1 and BSR-2 resins in deionized water.

| resin | Cₘₐₓ (mMol/g) | K_{b} (mM⁻¹) |
|---|---|---|
| BSR-1 (pristine) | 1.21 ± 0.13 | 0.13 ± 0.05 |
| BSR-1 (regenerated) | 1.23 ± 0.16 | 0.13 ± 0.06 |
| BSR-2 (pristine) | 1.93 ± 0.04 | 0.26 ± 0.03 |
| BSR-2 (regenerated) | 1.92 ± 0.05 | 0.26 ± 0.04 |

While embodiments and applications have been shown and described, it would be apparent to those skilled in the art having the benefit of this disclosure that many more modifications than mentioned above are possible without departing from the inventive concepts disclosed herein. The invention, therefore, and the scope of the appended claims, should not be limited to the embodiments described herein.

What is claimed is:

1. An oxoanion-selective microparticle comprising a hyperbranched macromolecular structure (A) comprising a plurality of branches, a plurality of terminal functional groups, and a plurality of cross-linking moieties within the same molecular structure;
wherein each of said plurality of branches comprises an N-substituted or N,N-substituted n-aminoalkyl moiety (B) comprising one or two substituent moieties;
wherein each of said substituent moieties comprises one of the following:
(a) another of said plurality of branches;
(b) one of the plurality of terminal functional groups; or
(c) one of the cross-linking moieties attached at a first cross-linking end, wherein the cross-linking moiety further comprises a second cross-linking end, by which the moiety is also one of said substituent moieties of one of said plurality of branches at a different location within the hyperbranched macromolecular structure A;
wherein A has a molecular weight of at least 1500 grams per mole;
wherein A comprises essentially no primary amine moieties; and
wherein each of the plurality of terminal functional groups comprises a vicinal diol moiety.

2. The microparticle of claim 1, wherein the cross-linking moieties consist of a carbon backbone of at least three carbon atoms, each carbon atom optionally substituted with one or more functional groups.

3. The microparticle of claim 2, wherein the cross-linking moieties are selected from the group consisting of —CH₂—CHOH—CH₂— and —CH₂—CH₂—CH₂—

4. The microparticle of claim 1, wherein the terminal functional groups are 2,3-dihydroxypropyl.

5. The microparticle of claim 1, wherein the terminal functional groups are (2R,3S,4R,5R)-2,3,4,5,6-pentahydroxyhexanoyl.

6. The microparticle of claim 1, wherein the terminal functional groups are (2R,3R,4R,5R)-2,3,4,5,6-pentahydroxyhexyl.

7. The microparticle of claim 1, wherein the mean diameter of the microparticle is greater than about 400 μM.

8. The microparticle of claim 1, wherein the mean diameter of the microparticle is greater than about 50 μM.

9. The microparticle of claim 1, wherein the boron sorption capacity of the microparticle is greater than about 1.5 mMol/g in aqueous solution, when the equilibrium boron concentration of the microparticle is about 100 mM.

10. A method for preparing an oxoanion-selective microparticle comprising:
(a) providing a branched polyethyleneimine molecule with a molecular weight of at least 1500 grams per mole;
(b) reacting the branched polyethyleneimine molecule with at least one cross-linking agent to produce a cross-linked resin matrix comprising a plurality of primary and/or secondary amine moieties; and
(c) after step (b), reacting the cross-linked resin matrix with a functionalization agent comprising a functional group —R, such that each of said primary and/or secondary amine moieties is substituted for the functional group —R, wherein —R is a structure comprising at least one vicinal diol moiety.

11. The method of claim 10, wherein each of the at least one the cross-linking agents contains a carbon chain with two ends, with a first linking functional group on the first end, and a second linking functional group on the second end, wherein the first and second linking functional groups are selected from the group consisting of acyl and epoxyethyl.

12. The method of claim 11, wherein each of the at least one cross-linking agents is selected from the group consisting of epichlorohydrin and 1-bromo-3-chloropropane.

13. The method of claim 12, wherein the cross-linking agents comprise both epichlorohydrin and 1-bromo-3-chloropropane.

14. The method of claim 10, wherein the functionalization agent is D-Glucono-1,5-lactone.

15. The method of claim 10, wherein the functionalization agent is oxiran-2-ylmethanol.

16. The method of claim 15, further comprising:
(d) after step (c), reacting the cross-linked resin matrix with 4-toluenesultonyl chloride;
(e) after step (d), reacting the cross-linked resin matrix with n-methyl glucamine.

17. The method of claim 10, wherein the functionalization agent is mannitol epoxide.

18. An oxoanion-selective microparticle prepared by the method of claim 10.

19. A method for filtering oxoanions from an aqueous solution, comprising:
providing a solution containing a first quantity of an oxoanion selected from the group consisting of borate, germanate, arsenate (V), arsenate (III), vanadate, molybdate, and tungstate;
providing a stationary bed comprising the microparticles of claim 1, having voids between said microparticles to allow the passage of an aqueous solution;
passing said solution through said stationary bed; and
recovering said solution after it passes through said stationary bed.

20. The method of claim 19, further comprising:
passing an acid solution through said stationary bed to leach the oxoanion from the microparticles; and
passing a basic solution through said stationary bed to regenerate the microparticles.
